(19) United States
(12) Patent Application Publication
(10) Pub. No.: US 2005/0075004 A1
(43) Pub. Date: Apr. 7, 2005

(54) Connector for flexible printed circuit board

(75) Inventors: Toshio Endou, Tokyo (JP); Masaaki Ooya, Yokohama-shi (JP); Seiichiro Mithuhashi, Noda-shi (JP)

Correspondence Address: Finnegan, Henderson, Farabow,;Garrett & Dunner, L.L.P., 1300 I Street, N.W., Washington, DC, 20005-3315, US

(73) Assignee: YAMAICHI ELECTRONICS CO., LTD.

(21) Appl. No.: 10/954,491

(22) Filed: Oct. 1, 2004

(30) Foreign Application Priority Data
Oct. 3, 2003 (JP) 2003-346284
Aug. 19, 2004 (JP) 2004-239954

(51) Int. Cl. H01R 12/24

(52) U.S. Cl. 439/495

(57) ABSTRACT

An FPC connector having an electromagnetic wave shielding structure improved so that noises do not exceed an allowable value. The FPC connector includes at least a top plate, a metallic shell having left and right walls and a grounding terminal portion, a connector body covered with the metallic shell, a signal line contact, and a grounding contact for grounding the FPC, wherein the metallic shell has a grounding contact partially cut from the top plate and raised the cut portion.

This application claims priority from Japanese Patent Application Nos. 2003-346284 filed Oct. 3, 2003 and 2004-239954 filed Aug. 19, 2004, which are incorporated hereinto by reference.

### BACKGROUND OF THE INVENTION

1. Field of the Invention

The present invention relates to a connector for a flexible printed circuit board for mutually connecting electronic components in electronic apparatuses (hereinafter referred to as an FPC connector), more specifically, to the FPC connector improved for forming a ground contact in the FPC connector for avoiding the interfere of electromagnetic waves with the flexible printed circuit (hereinafter referred to as an FPC).

2. Description of the Related Art

Up to now, in the FPC connector, part or all of the connector is covered with a metallic shell and the metallic shell and FPC are grounded for shielding the FPC connector from the electromagnetic field as well as suppressing the generation of noise in a signal line or grounding the generated noise as much as possible (see Japanese Patent No. 3425696).

A typical conventional shield structure is illustrated in FIG. 7 which is an enlarged sectional view of a portion thereof for grounding the FPC when the FPC is inserted into a FPC connector.

The FPC connector 101 generally includes a metallic shell 102, a connector body 103, a pair of grounding contacts 104 and a plurality of signal line contacts 105.

The metallic shell 102 functions as a shield for electromagnetic waves and covers at least upper and left/right sides of the connector body 103 so that it is suitably grounded via the left/right sides to an electronic apparatus to which the FPC connector 101 is attached. The connector body 103 is made of insulating resin and formed as a rectangular tube having an outer shape of substantially a parallelepiped, through which a space 103a extends forward/rearward. The grounding contacts 104 is press-fit and fixed into grooves 103d formed in a bottom wall 103c constituting the space 103a of the connector body 103 in correspondence to a grounding pads (not shown) in FPC 110 inserted therein. As shown in FIG. 7, the grounding contact 104 is of a generally U-shape and has a contact portion 104a to be in contact with the grounding pad of the FPC 110, a grounding portion 104b at the other end, and a fixing portion 104c to be press-fit into the groove 103d in a middle region thereof. The grounding portion 104b is grounded the electronic apparatus to which the FPC connector is attached. The signal line contact 105 includes a contact portion to be in contact with the pad of the FPC 110, a fixing portion to be fixed to the connector body 103 and a terminal portion 105a to be connected to a circuit of the electronic apparatus (see Japanese Patent No. 3425696 or others).

As shown in FIG. 7, when the FPC 110 is guided along an inside surface of an upper wall 103b of the FPC connector 101 and inserted into the space 103a, the grounding contact 104 and the signal line contact 105 fixed to the bottom wall 103c are brought into contact with the corresponding pad of the FPC 110 from the lower side; i.e., from the bottom wall side.

The conventional FPC connector reduces the interference from electromagnetic waves by the above-mentioned electromagnetic wave shielding structure. However, in the conventional FPC connector, since the grounding contact 104 of the FPC is fixed to the bottom wall 103c of the connector body 103 and brought into contact with the FPC 110 from underside, the manufacturing error of the depth of the groove 103d and the grounding contact 104 itself is generated. Therefore, it is impossible to always maintain a gap between the contact portion 104a of the grounding contact 104 and the inside surface of the upper wall 103b of the connector body 103 at a constant value. This may result in the adverse contact between the grounding contact 104 and the FPC, which impedes the stable contact. As a result, there is a risk of increasing noises, far from reducing them.

FIG. 8 is a graph of the measurement of the radiated disturbance of the conventional FPC connector (the electromagnetic disturbance wherein the energy thereof is propagated through a space as electromagnetic waves). As shown in FIG. 8, it is apparent that noises having the field strength exceeding the allowable value (the limit line shown by a solid line in the graph) generate in the signal line even in the above-mentioned electromagnetic wave shielding structure.

The present invention has been made in view of such a problem, and an object thereof is to provide an FPC connector having an electromagnetic wave shielding structure improved so that noises are prevented from exceeding the allowable value.

### SUMMARY OF THE INVENTION

To achieve the above-mentioned object, the FPC connector in accordance with the present invention comprises at least a top plate, a metallic shell having left and right walls and a grounding terminal portion, a connector body covered with the metallic shell, a signal line contact, and a grounding contact for grounding the flexible circuit board, wherein the metallic shell has a grounding contact partially cut from the top plate and raised the cut portion.

The metallic shell preferably further comprises a fixing piece to be press-fit in the connector body, formed by partially cutting from the top plate and bending the cut portion in parallel to the side wall of the metallic shell.

The metallic shell preferably further comprises an FPC-fixing/removing spring piece formed by partially cutting from the top plate and raising the cut portion, and the FPC-fixing/removing member is held by the spring piece.

According to the FPC connector of the present invention, it is possible to reduce the manufacturing error in comparison with the prior art wherein the grounding contact is formed as a separate member and attached to the connector body, whereby the electric contact of the FPC with the grounding contacts is further ensured. As a result, it is possible to prevent noises from exceeding the allowable value. Also, since the grounding contact is formed integral with the metallic shell, it is possible to decrease the number of parts and simplify the production process, whereby the production cost is saved.

By press-fitting the metallic shell into the contact body from the rear side thereof with the fixing piece, it is possible to easily position the grounding contact.

Further, by partially cutting the spring piece for the FPC-fixing/removing mechanism from the metallic shell and raising the cut portion, it is possible to reduce the production steps and thereby to save the production cost.

Also, by providing the FPC-fixing/removing mechanism, the inserted FPC does not fall off from the FPC connector.

The above and other objects, effects, features and advantages of the present invention will become more apparent from the following description of embodiments thereof taken in conjunction with the accompanying drawings.

### BRIEF DESCRIPTION OF THE DRAWINGS

FIG. 1A is an upper plan view of the FPC connector in accordance with the present invention;

FIG. 1B is a perspective view of the FPC connector in accordance with the present invention;

FIG. 2 is a perspective view of a metallic shell of the FPC connector;

FIG. 3A is a sectional view of the FPC connector taken along a line A-A when the FPC is not inserted;

FIG. 3B is a sectional view of the FPC connector taken along a line B-B when the FPC is not inserted;

FIG. 4A is a sectional view of the FPC connector corresponding to FIG. 3A when the FPC is inserted;

FIG. 4B is a sectional view of the FPC connector corresponding to FIG. 3B when the FPC is inserted;

FIG. 5 is a schematic plan view of a stopper member 7 constituting an FPC-fixing/removing mechanism;

FIG. 6A is a sectional view taken along a line C-C in FIG. 1A when the FPC is not inserted;

FIG. 6B is a sectional view taken along a line C-C in FIG. 1A when the FPC is inserted;

FIG. 6C is a sectional view taken along a line C-C in FIG. 1A illustrating a state of the FPC-fixing/removing mechanism after the FPC has been inserted;

FIG. 7 is an sectional view of a portion for grounding FPC when the FPC is inserted into the conventional FPC connector; and

FIG. 8 is a graph illustrating the field strength of noises generated in the conventional FPC connector by the radiated disturbance.

### DETAILED DESCRIPTION OF PREFERRED EMBODIMENTS

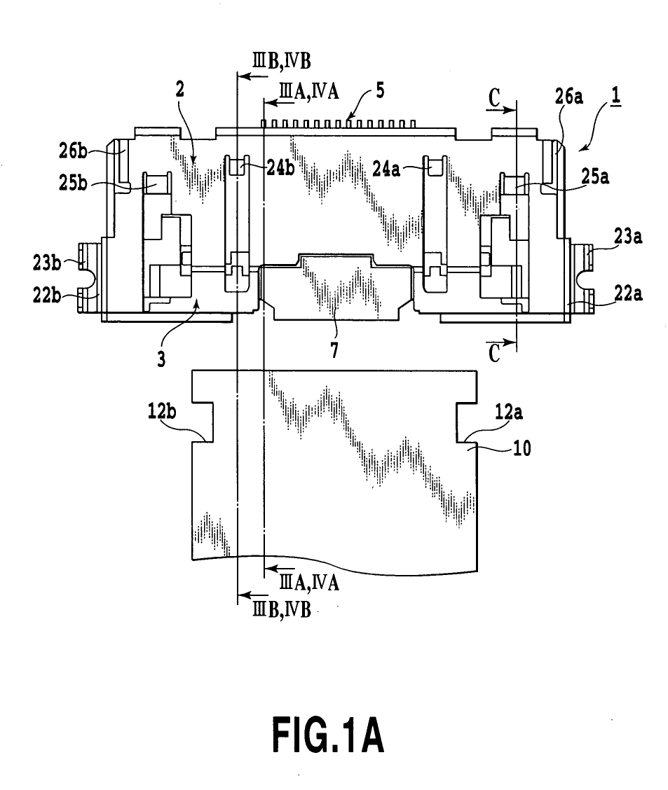

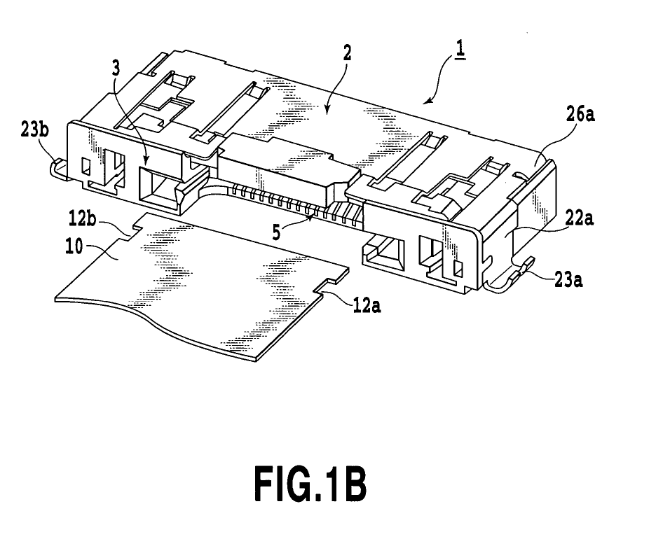

The preferred embodiments of the present invention will be described below with reference to FIGS. 1A to 4B.

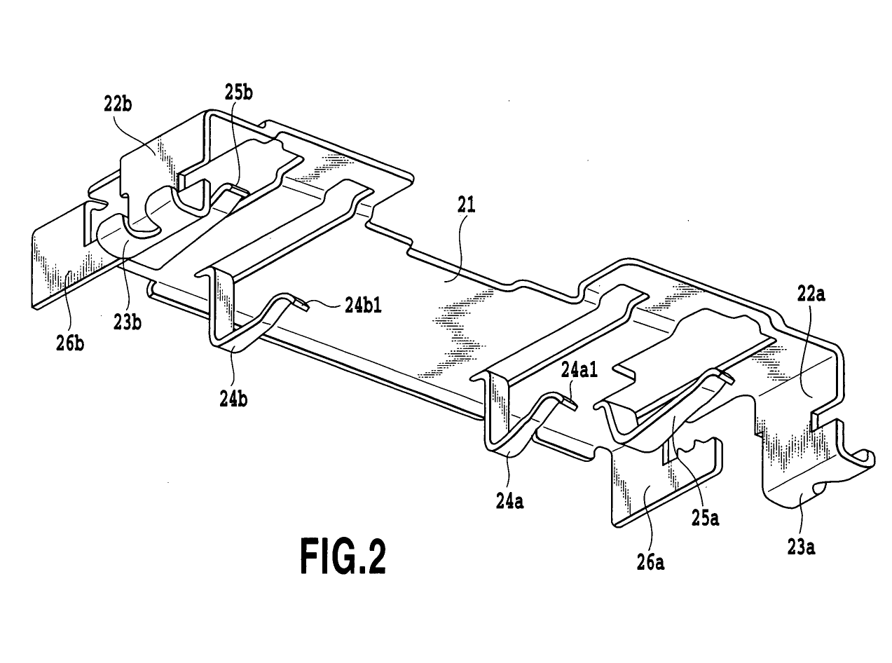

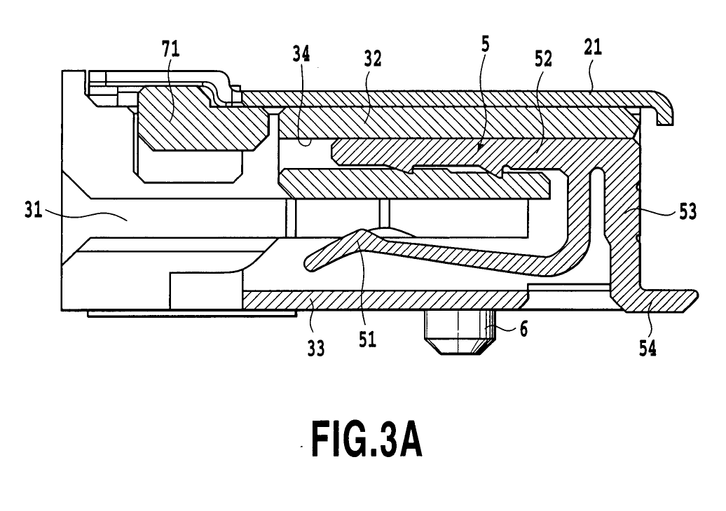

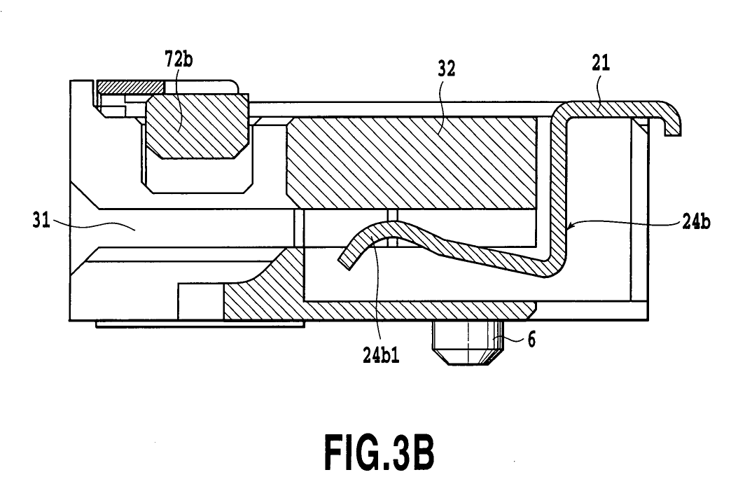

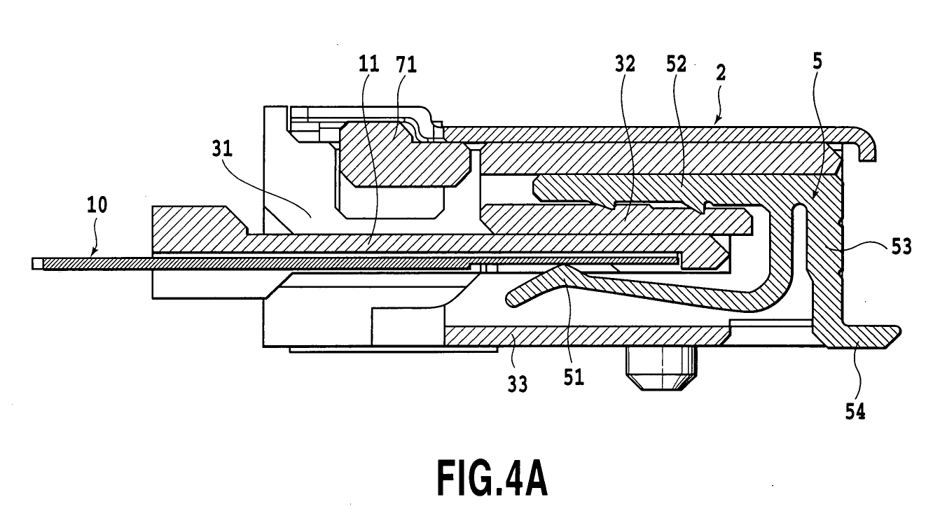

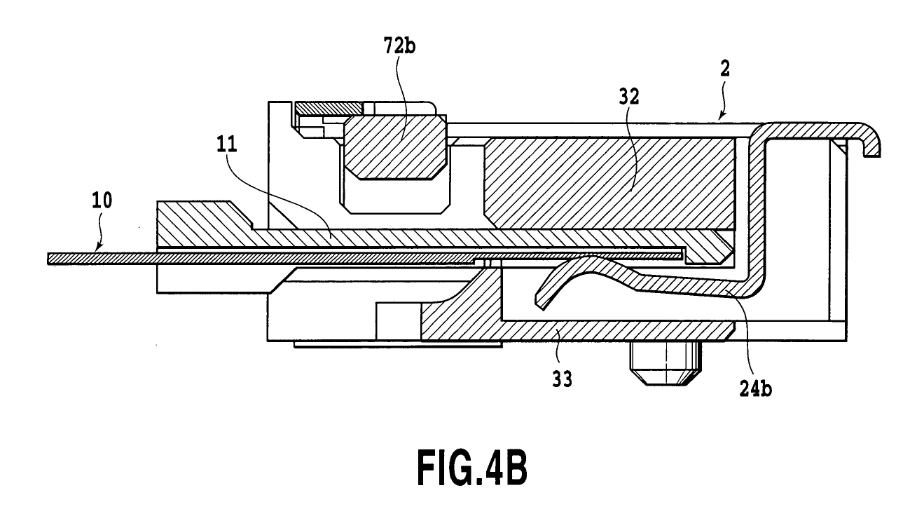

FIGS. 1A and 1B illustrate the FPC connector in accordance with the present invention, wherein FIG. 1A is an upper view thereof; FIG. 1B is a perspective view thereof; FIG. 2 is a perspective view of a metallic shell of the FPC connector; FIGS. 3A and 3B are sectional views of the FPC connector when the FPC is not inserted, more specifically FIG. 3A is a sectional view taken along a line A-A in FIG. 1A and FIG. 3B is a sectional view taken along a line B-B in FIG. 1A; and FIGS. 4A and 4B are sectional views of the FPC connector similar to FIGS. 3A and 3B when the FPC is inserted, more specifically FIG. 4A is a sectional view taken along a line A-A in FIG. 1A and FIG. 3B is a sectional view taken along a line B-B in FIG. 1A.

As shown in FIGS. 1A and 1B, the FPC connector in accordance with the present invention generally includes a metallic shell 2, a connector body 3 and a plurality of signal line contacts 5.

The metallic shell 2 functions for shielding electromagnetic waves in a similar manner as in the prior art. The metallic shell 2 includes a top plate 21 for covering at least an upper portion of the connector body 3, and side walls 22a, 22b for covering left and right portions of the connector body 3. The metallic shell 2 is suitably grounded via grounding terminal portions 23a, 23b provided at lower ends of the left and right side walls 22a, 22b, respectively, to an electronic apparatus to which the FPC connector 1 is attached.

According to the present invention, as clearly shown in FIG. 2, a pair of grounding contacts 24a, 24b is formed integral with the metallic shell 2 in correspondence to grounding pads of the FPC 10. Each of the grounding contacts 24a, 24b is formed, for example, by partially press-cutting from the top plate 21 of the metallic shell 2 and raising the cut portion to be a piece having a predetermined shape extending downward from the top plate in the vertical direction, which piece is then bent to have a generally L-shape with a C-shaped free end. In this production process, the pair of grounding contacts 24a, 24b having the FPC contact portions 24a1, 24b1, which are elastically deformable free ends, are formed at the same time.

By forming the pair of grounding contacts 24a, 24b in such a manner and sandwiching the FPC 10 between the top plate 21 of the metallic shell 2 and the grounding contacts 24a, 24b along an upper wall 32 of the connector body 3 (see FIG. 4B), it is possible to reduce the manufacturing error in comparison with the prior art wherein the grounding contact is formed as a separate member and attached to the connector body 3, whereby the electric contact of the FPC with the grounding contacts 24a, 24b is further ensured. Also, since the grounding contacts 24a, 24b are formed integral with the metallic shell 2, it is possible to decrease the number of parts and simplify the manufacturing process as well as save the production cost.

In this regard, in FIG. 2, reference numerals 25a, 25b denote a pair of spring pieces for facilitating the attachment/detachment of the FPC 10 relative to the connector 1 described later, which constitutes a FPC-fixing/removing mechanism. The pair of spring pieces 25a, 25b is disposed outside the pair of grounding contacts 24a, 24b, and is partially cut from the top plate 21 of the metallic shell 2 and raised the cut portion in a similar manner as the pair of grounding contacts 24a, 24b. Also, reference numerals 26a, 26b denote a pair of fixing pieces for fixing the metallic shell 2 to the connector body 3, which is partially cut from the top plate 21 and bent the cut portion in parallel to the side walls 22a, 22b, respectively, in a rear area (an upper area in FIG. 1A) of the metallic shell 2. The pair of spring pieces 25a, 25b and the pair of fixing pieces 26a, 26b may be formed at the same time in the process for forming the grounding contacts 24a, 24b.

The contact body 3 is made of insulating resin to have an outer shape of a generally parallelepiped and formed as a rectangular tube, through which a space 31 extends forward/rearward of the connector body 3 (the upward/downward direction in FIG. 1A). In the space 31, the FPC 10 can be inserted. The connector body 3 is provided with a stopper member 7 constituting a fixing/removing mechanism for facilitating the attachment/detachment of the FPC in front of the upper wall 32 defining the upper limit of the space 31 (in a lower area in FIG. 1A), and a positioning projection 6 for attaching the connector body to the electronic apparatus at a predetermined position in a lower area of a lower wall 33 defining a lower limit of the space 31 (see FIGS. 3A and 3B).

The fixing piece 26 of the metallic shell 2 and bases 52 of the signal line contacts 5 described later are press-fit into holes formed respectively in the connector body 3 in correspondence thereto from a rear side of the connector body 3 (from the upper side in FIG. 1A and the right side in FIGS. 3A to 4B), whereby the metallic shell 2 and the signal line contacts 5 are fixed to the connector body 3. Simultaneously therewith, the pair of grounding contacts 24, 24 and the signal line contacts 5 are correctly located in the interior of the space 31 of the contact body 3.

As shown in FIGS. 3A and 4A, the signal line contact 5 includes a movable contact portion 51 brought into contact with a signal line pad of the FPC corresponding thereto, a base 52 press-fit into a hole or a slit 34 formed in the connector body 3, a terminal portion 54 as a soldering portion being electrically connected to an electrode pad of the circuit board in the electronic apparatus, and a coupling portion 53 for coupling the movable contact portion 51 and the base 52 with the terminal portion 54. As clearly shown in FIG. 4A, the signal line contact 5 is formed to sandwich the FPC 10 between the base 52 and the movable contact portion 51 via the upper wall 32 of the connector body 3.

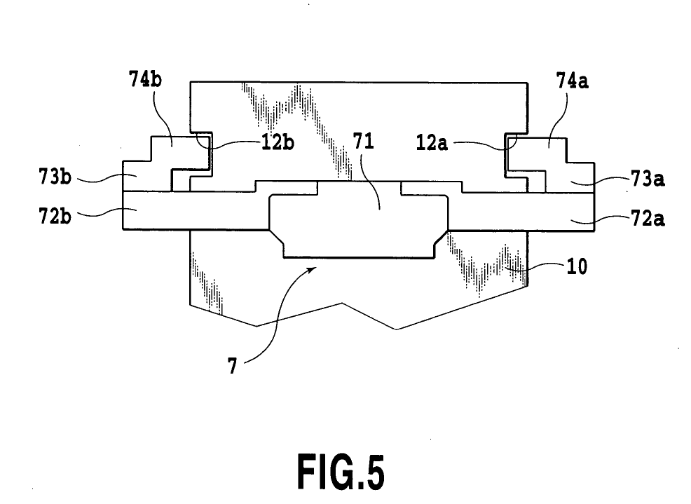

Next, the FPC-fixing/removing mechanism for facilitating the attachment/detachment of the FPC will be described with reference to FIG. 5. FIG. 5 is a schematic plan view of the stopper member 7 constituting the FPC-fixing/removing mechanism wherein the FPC 10 is inserted.

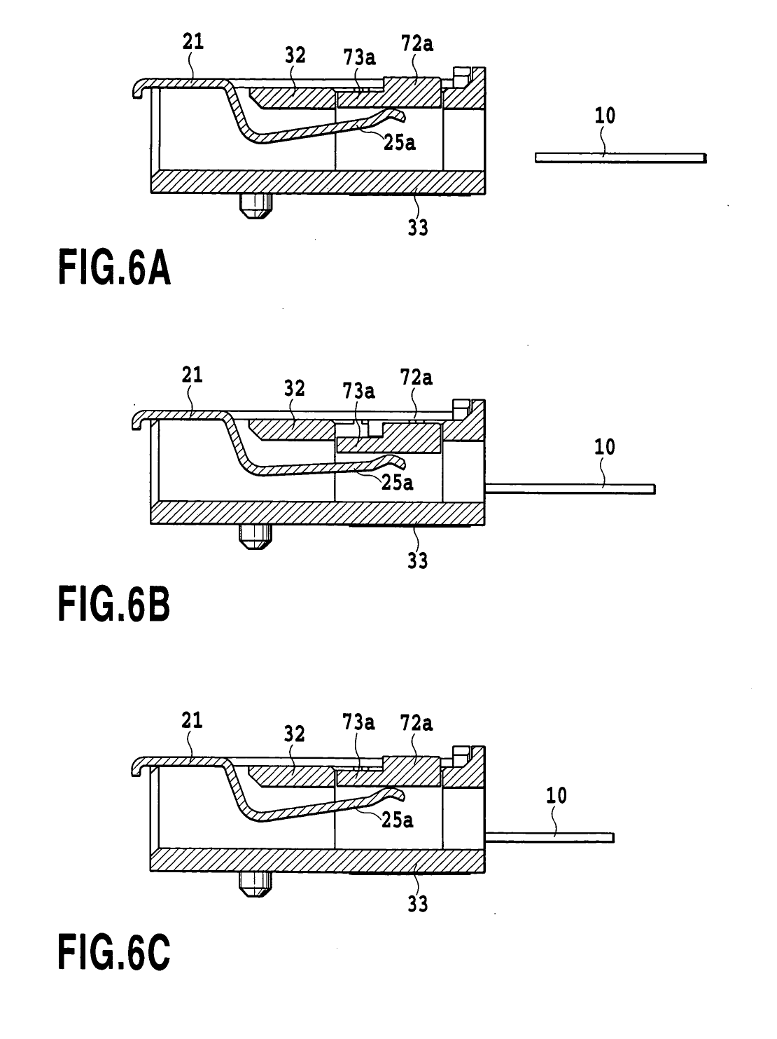

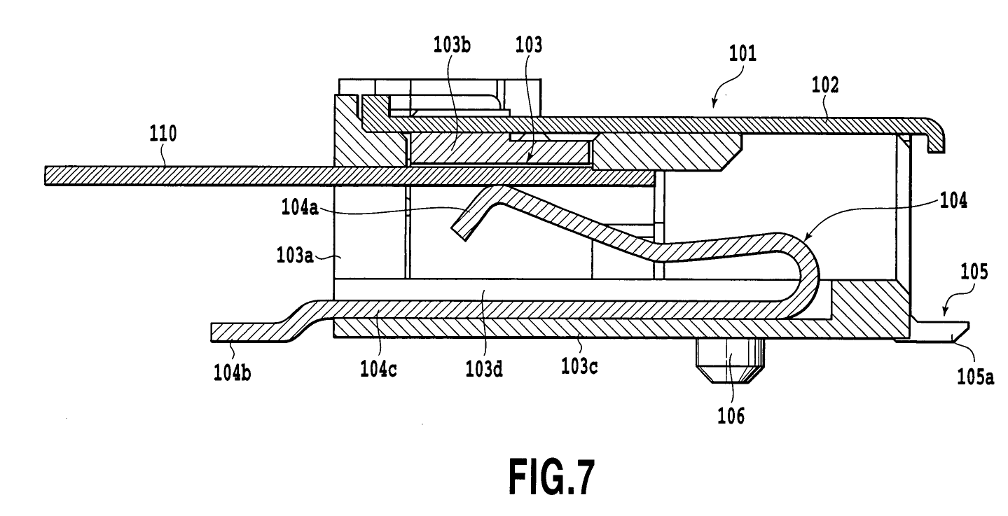

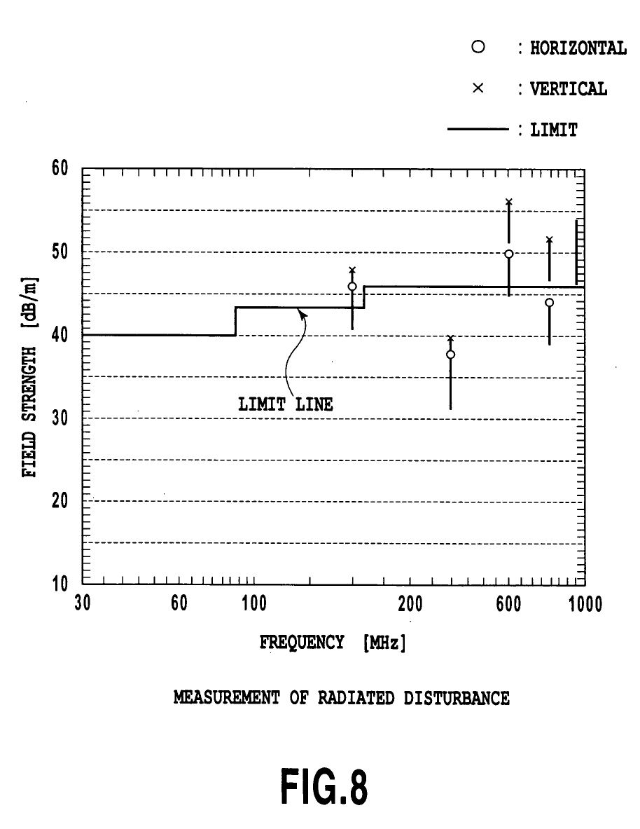

The stopper member 7 includes a push button 71 located in a generally middle portion thereof, a pair of arm members 72a, 72b extending leftward and rightward from the push button 71, a pair of projections 73a, 73b extending rearward from front ends which are free ends of the arm members 72a, 72b generally in the vertical direction thereto, and a pair of engagement members 74a, 74b extending inward (to a center) from front ends of the projections 73a, 73b generally in the vertical direction thereto. The front ends of the pair of arm members 72a, 72b are elastically held by the pair of spring pieces 25a, 25b partially cut from the top plate 21 of the metallic shell 2 and raised the cut portion to be located on the lower side (the back side of the paper in FIG. 5) (see FIG. 6A). Also, the pair of engagement members 74a, 74b is projected inward from the projections 73a, 73b to be located on a passage of the FPC 10 inserted into the space 31. Accordingly, they are engageable with a pair of recesses 12a, 12b formed on both sides of the front end of the FPC 10 inserted.

The operation of the FPC-fixing/removing mechanism of the above-mentioned structure will be described with reference to FIGS. 6A to 6C. FIGS. 6A to 6C are the C-C cross-section in FIG. 1A and illustrate the operation of the spring piece and the stopper member constituting the FPC-fixing/removing mechanism.

As shown in FIG. 6A, when the FPC 10 is absent, the stopper member 7, more accurately the arm members 72a, 72b are pushed upward by the corresponding spring pieces 25a, 25b.

In FIG. 6B, when the FPC 10 is inserted into the FPC connector 1, the push button 71 of the stopper member 7 is pushed down by a finger or others. Then, the arm members 72a, 72b formed in integral with the push button 71 are also pushed down against the elastic force of the spring pieces 25a, 25b. Thereby, the projections 73a, 73b and the engagement members 74a, 74b formed in integral with the arm members 72a, 72b are also pushed down.

When the engagement members 74a, 74b are pushed down to get out of the passage of the FPC 10, the FPC 10 can be inserted to a predetermined position in the space 31. When the pressure applied to the push button 71 is released after the FPC 10 has completely been inserted, the stopper member 7 including the arm members 72a, 72b returns to the original position (see FIG. 6C). Accordingly, the engagement members 74a, 74b also return to the passage of the FPC 10 in the space 31.

At this time, if the FPC 10 is inserted to the predetermined position, the engagement members 74a, 74b are fit into the recesses 12a, 12b. Thereby, the FPC 10 is electrically brought into contact with the signal line contacts 5 and the grounding contacts 24a, 24b, and assuredly fit to the FPC connector 1 without falling off therefrom.

When the FPC 10 is detached from the FPC connector 1, the push button 71 of the stopper member 7 is pushed down in a similar manner as shown in FIG. 6B to detach the engagement members 74a, 74b from the corresponding recesses 12a, 12b of the FPC 10. Thereby, the FPC 10 is removable from the connector 1.

Since the FPC connector 1 in accordance with the present invention is structured as described above, if the FPC is inserted into the space 31 from the front side of the connector body 3, the respective pads of the FPC 10 are electrically connected to the respective signal line contacts 5 corresponding thereto while being sandwiched between the upper wall 32 of the connector body 3 and the signal line contacts 5 or the grounding contacts 24 as shown in FIGS. 4A and 4B, and the FPC 10 is assuredly held in the connector 1 by the action of the FPC-fixing/removing mechanism, whereby the FPC 10 does not fall off from the connector 1 during the use. In this regard, reference numeral 11 shown in FIGS. 4A and 4B denotes a spacer of insulating resin attached to the back side of the FPC (opposite to a side on which the pads are formed), which is not indispensable but preferably provided for ensuring the attachment/detachment of the FPC relative to the connector or increasing the contact pressure of the pads in the FPC and the respective contacts.

The present invention has been described in detail with respect to preferred embodiments, and it will now be apparent from the foregoing to those skilled in the art that changes and modifications may be made without departing from the invention in its broader aspect, and it is the intention, therefore, in the apparent claims to cover all such changes and modifications as fall within the true spirit of the invention.

1. A connector for a flexible printed circuit board comprising at least a top plate, a metallic shell having left and right walls and a grounding terminal portion, a connector body covered with the metallic shell, a signal line contact, and a grounding contact for grounding the flexible printed circuit,
wherein the metallic shell has the grounding contact partially cut from the top plate and raised the cut portion.

2. A connector for a flexible circuit board as claimed in claim 1, wherein the metallic shell further comprises a fixing piece to be press-fit in the connector body, formed by partially cutting from the top plate and bending the cut portion in parallel to the side wall of the metallic shell.

3. A connector for a flexible circuit board as claimed in claim 1, wherein the metallic shell further comprises a spring piece for an FPC-fixing/removing mechanism formed by partially cutting from the top plate and raising the cut portion.

4. A connector for a flexible circuit board as claimed in claim 3, wherein a stopper member for the FPC-fixing/removing mechanism is held by the spring piece.
